(19) United States
(12) Patent Application Publication
(10) Pub. No.: US 2005/0053894 A1
(43) Pub. Date: Mar. 10, 2005

(54) Method of preventing inner crown of removable restoration tooth from becoming disengaged with natural or artificial abutment tooth and the structure of the inner crown

(76) Inventor: Wen-Yuen Wu, Kaohsiung (TW)

Correspondence Address: BACON & THOMAS, PLLC, 625 SLATERS LANE, FOURTH FLOOR, ALEXANDRIA, VA, 22314, US

(21) Appl. No.: 10/654,991

(22) Filed: Sep. 5, 2003

(51) Int. Cl. A61C 3/00

(52) U.S. Cl. 433/18

(57) ABSTRACT

A method is designed to mount an inner crown of a restoration tooth on a natural or artificial abutment. The method involves a first step in which the inner crown is provided in a hollow interior with a cement coating before the inner crown is fitted over the natural or artificial abutment. The natural or artificial abutment is then provided with a retaining hole which is drilled into an interior of the natural or artificial abutment from one upright wall of the inner crown. The retaining hole is used to retain a retention pin or securing the inner crown to the natural or artificial abutment. The inner crown is thus prevented from becoming disengaged with the natural or artificial abutment by the cement coating and the retention pin.

### FIELD OF THE PRESENT INVENTION

The present invention relates generally to dental restorative devices, and more particularly to a method of preventing inner crown of a removable restoration tooth from becoming disengaged with a natural or artificial abutment tooth.

### BACKGROUND OF THE PRESENT INVENTION

A decayed or diseased tooth is generally restored to its former condition by means of a restoration tooth, which may be either fixed or removable.

As illustrated in FIGS. 1-3, a process of making a fixed restoration tooth “t” involves a first step in which a decayed or diseased tooth is mended such that it is provided with an abutment 1, as shown in FIG. 2. Thereafter, a print of the abutment 1 is made. On the basis of the abutment print, a restoration tooth “t” is formed by a dental technician. The restoration tooth so formed is provided therein with a crown seat 2, as shown in FIG. 3.

As illustrated in FIGS. 2-5, the mounting of the restoration tooth “t” involves a first step in which an appropriate amount of cement “C” is injected into the crown seat 2. Thereafter, the crown seat 2 is fitted over the abutment 1, so as to mount fixedly the restoration tooth “t” on the abutment of the decayed or diseased tooth. In another words, the decayed or diseased tooth is restored, as illustrated in FIGS. 5 and 6. However, there is a gap “δ” between the restoration tooth “t” and a healthy tooth “N” adjacent to the restoration tooth “t”, as shown in FIG. 6. The food particles are apt to deposit in the gap “δ”, which becomes a breeding ground for bacteria responsible for inflammation of the gums. In light of the restoration tooth “t” being mounted fixedly, it can not be removed in its entirety and replaced with a new one. For this reason, the fixed restoration tooth is less popular than a removable restoration tooth, which is described hereinafter with reference to FIGS. 7-9.

The process of making the removable restoration tooth “T” involves a first step in which a decayed or diseased tooth 10 is provided with an abutment 11, as shown in FIG. 8. A print of the abutment 11 is made. On the basis of the abutment print, a hollow inner crown 20 is made by a dental technician. The inner crown 20 is then fitted over the abutment 11. Thereafter, a print of the inner crown 20 is made. On the basis of the print of the inner crown 20, the removable restoration tooth “T” is made by a dental technician such that the removable restoration tooth “T” is provided therein with an outer crown 30 which is shaped to fit over the inner crown 20, as illustrated in FIG. 9.

As illustrated in FIGS. 9-11, The mounting of the removable restoration tooth “T” is done by first providing the inner wall of the hollow inner crown 20 with a coating of cement “C”. The inner crown 20 is then fitted over the abutment 11 of the decayed or diseased tooth 10. The inner crown 20 is fixedly joined with the abutment 11 by virtue of the cement coating. As the cement “C” hardens, the inner crown 20 is firmly fastened with the abutment 11. The removable restoration tooth “T” is finally mounted on the abutment 11 by fitting the outer crown 30 of the removable restoration tooth “T” over the inner crown 20, as shown in FIG. 11.

As shown in FIG. 13-A, a gap “δ” is formed between the removable restoration tooth “T” and a healthy tooth “N” adjoining the restoration tooth “T”. The gap “δ” can be easily kept clean by removing temporarily the restoration tooth “T”, as illustrated in FIG. 13-B. As a result, the gap “δ” is no longer a culprit for the gums inflammation. Accordingly, the longevity of the restored tooth 10 is effectively prolonged.

As shown in FIGS. 14-A and 14-B, two teeth 10 are restored by a bridge—type restoration tooth T′, which can be removed to facilitate the cleaning of a gap “δ′”. Upon completion of the cleaning of the gap “δ”, the restoration tooth T′ is rejoined with the two teeth 10.

Such a conventional removable restoration teeth “T” as described above has its own share of deficiencies. As illustrated in FIG. 12, the outer crown 30 of the removable restoration tooth “T” has two upright inner contact surfaces 31, whereas the inner crown 20 has two upright outer contact surfaces 21. The outer crown 30 is fitted over the inner crown 20 such that the tolerance between the inner contact surfaces 31 and the outer contact surfaces 21 takes the form of interference fit instead of clearance fit. As a result, when an effort is made to remove the restoration tooth “T” from the abutment 11 of the restored tooth 10, a frictional force “F” of the inner contact surfaces 31 and the outer contact surfaces 21 produces a vertical component of force “F1” relative to the inner crown 20. The vertical component of force “F1” forms a tension against the inner crown 20 at the time when the outer crown 30 is detached from the inner crown 20. As a result, the inner crown 20 is vulnerable to becoming disengaged with the abutment 11 of the restored tooth 10. In addition, the outer contact surfaces 21 of the inner crown 20 are not uniformly exerted on by the force of a chewing action, thereby resulting in an irregular moment of force between the abutment 11 and the inner crown 20. In another words, the abutment 11 and the inner crown 20 are prone to separation. Moreover, the inner crown 20 of the removable restoration tooth “T” is fastened with the abutment 11 by the cement “C”, as illustrated in FIG. 11. The amount of the cement “C” coated on the inner side walls of the inner crown 20 can not be easily controlled with precision. The excess cement “C” is likely to flow out. Such a cement remnant, if not removed, can cause inflammation of the gums.

### SUMMARY OF THE PRESENT INVENTION

The primary objective of the present invention is to provide a method of preventing inner crown of a removable restoration tooth from becoming disengaged with a natural or artificial abutment. The method involves the use of a retention pin to hold firmly the inner crown and the natural or artificial abutment. The retention pin is retained in a retaining hole of a depth and extending from the inner crown into an interior of the abutment. A plurality of the retention pins may be used to reinforce the engagement of the inner crown with the abutment.

It is another objective of the present invention to provide a method of preventing inner crown of a removable restoration tooth from becoming disengaged with a natural or artificial abutment. The method involves the drilling of a drain hole in the inner crown. The drain hole is located in the top of the inner crown for drawing off an excess cement which is used to hold the inner crown and the abutment. The remnant of the excess cement can be easily removed from the top of the inner crown by a dentist.

It is still another objective of the present invention to provide a method of preventing inner crown of a removable restoration tooth from becoming disengaged with a natural or artificial abutment. The method involves the mounting of the inner crown on the abutment in such a way that a passage can be bored through the inner crown and the abutment for the purpose of treating the tooth root. The passage can be mended in the wake of the tooth root treatment.

The features and the advantages of the present invention will be more readily understood upon a thoughtful deliberation of the following detailed description of the preferred embodiments of the present invention with reference to the accompanying drawings.

### BRIEF DESCRIPTION OF THE DRAWINGS

FIG. 1 shows a process flow diagram of a prior art fixed restoration tooth.

FIG. 2 shows an exploded view of the prior art fixed restoration tooth.

FIG. 3 shows an exploded sectional view of the prior art fixed restoration tooth.

FIG. 4 shows a perspective view of the prior art fixed restoration tooth in combination.

FIG. 5 shows a sectional schematic view of the prior art fixed restoration tooth in combination.

FIG. 6 shows a schematic view of the prior art fixed restoration tooth and a healthy tooth adjoining thereto.

FIG. 7 shows a process flow diagram of a prior art removable restoration tooth.

FIG. 8 shows an exploded view of the prior art removable restoration tooth.

FIG. 9 shows an exploded sectional view of the prior art removable restoration tooth.

FIG. 10 shows a perspective view of the prior art removable restoration tooth in combination.

FIG. 11 shows a sectional view of the prior art removable restoration tooth in combination.

FIG. 12 shows a sectional schematic view of the prior art removable restoration tooth at work.

FIG. 13A shows a sectional schematic view of the prior art removable restoration tooth along with a healthy tooth adjoining thereto.

FIG. 13B shows a schematic view of the prior art removable restoration tooth at work.

FIG. 14A shows a sectional schematic view of a bridge—type restoration tooth of the prior art at work.

FIG. 14B shows another sectional schematic view of the bridge—type restoration tooth of the prior art at work.

FIG. 15 shows a schematic process of a first preferred embodiment of the present invention.

FIG. 16 shows a schematic view of the first preferred embodiment of the present invention at work.

FIG. 17 shows a schematic process of a second preferred embodiment of the present invention.

FIG. 18 shows a schematic process of a third preferred embodiment of the present invention.

FIG. 19 shows a schematic view of a fourth preferred embodiment of the present invention at work.

FIG. 20 shows a schematic process of the fourth preferred embodiment of the present invention.

FIG. 21 shows a schematic view of a fifth preferred embodiment of the present invention at work.

FIG. 22 shows a schematic process of the fifth preferred embodiment of the present invention.

FIG. 23 shows a schematic view of the a sixth preferred embodiment of the present invention.

FIG. 24 shows a schematic process of the sixth preferred embodiment of the present invention.

FIG. 25 shows a perspective view of an inner crown of the present invention.

FIG. 26 shows a sectional view taken along the direction indicated by a line A-A as shown in FIG. 25.

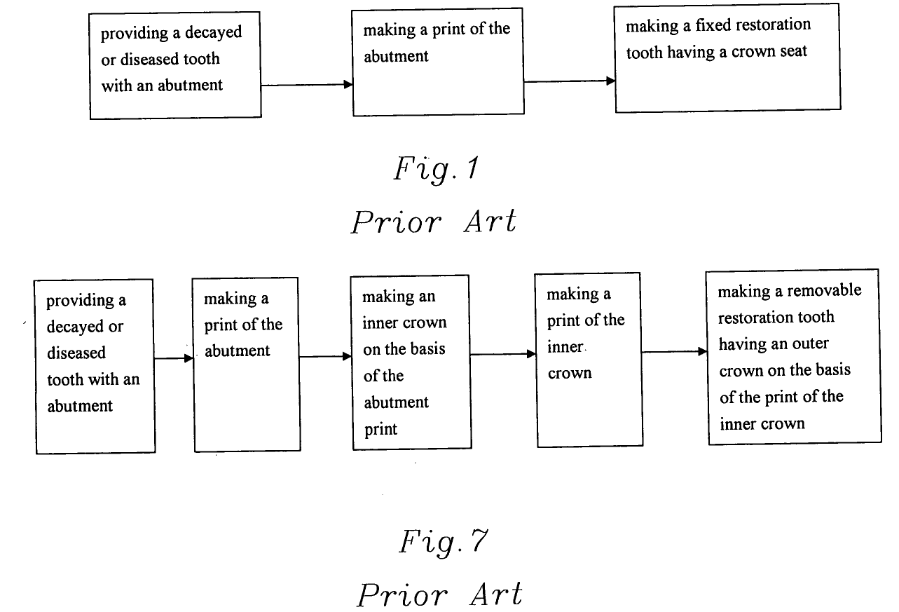

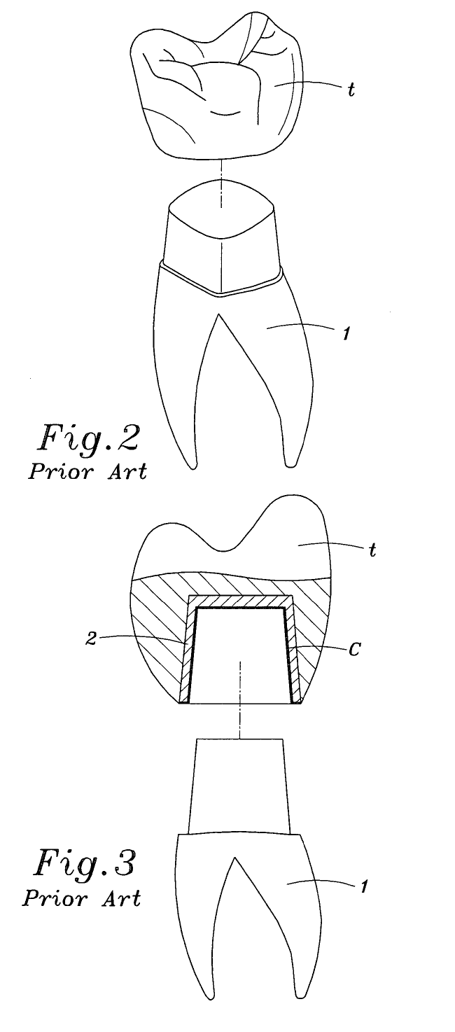

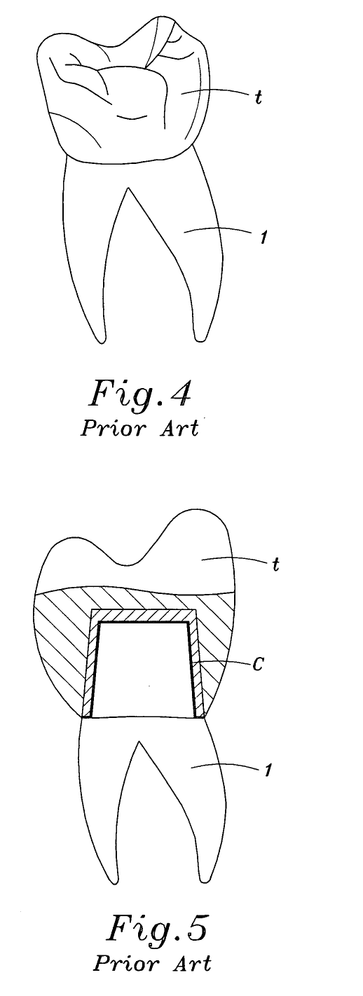

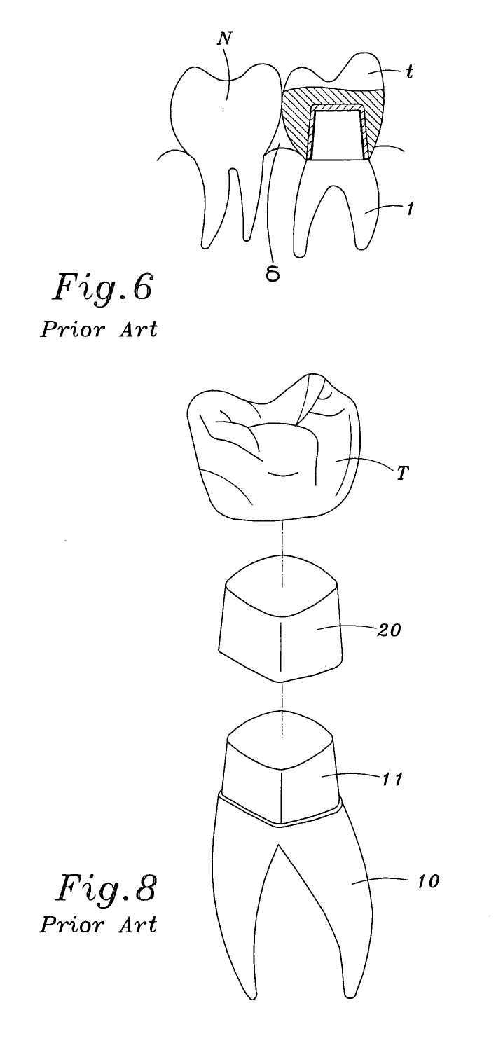

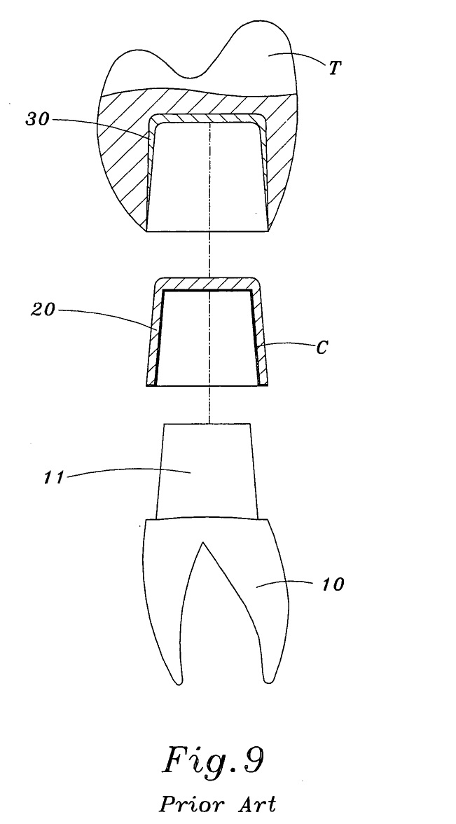

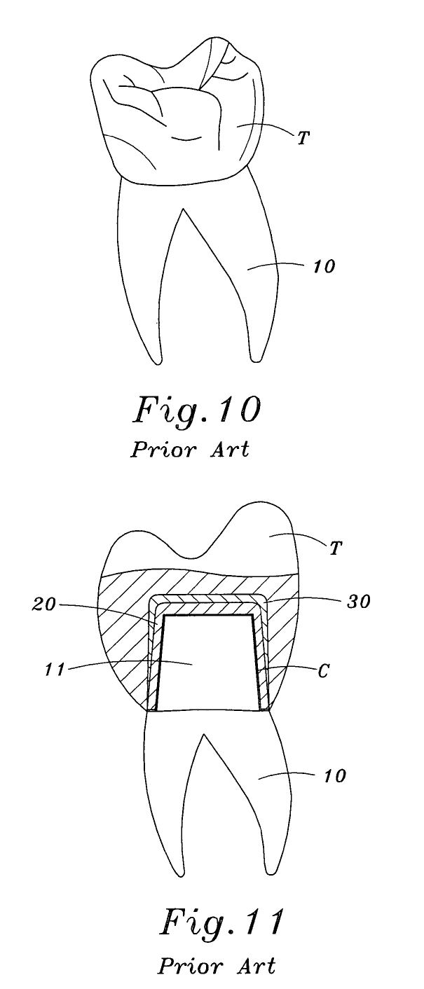

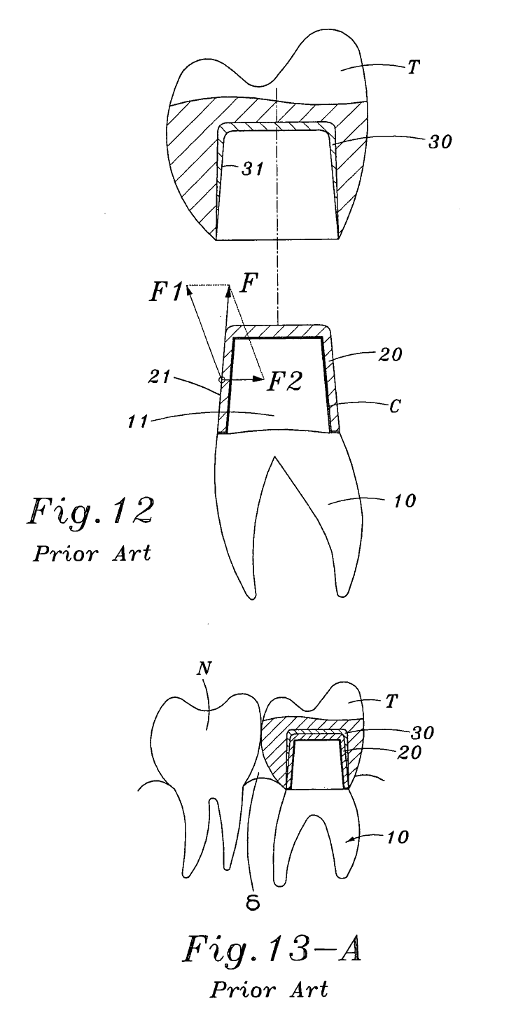

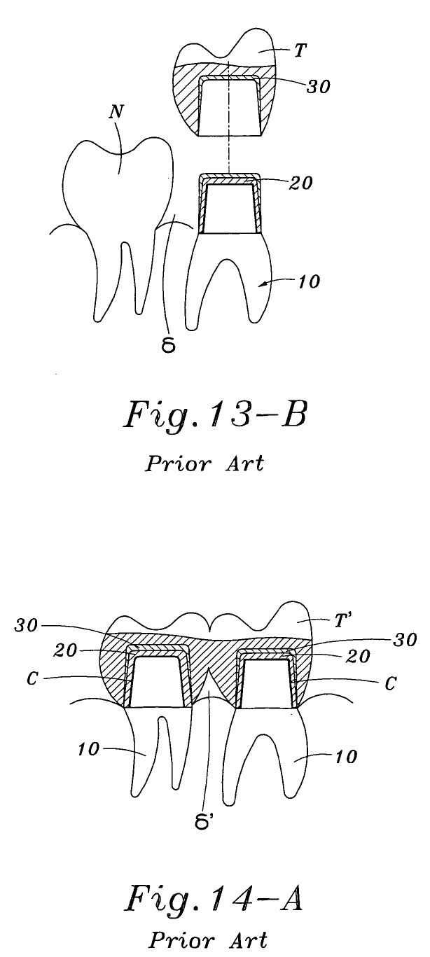

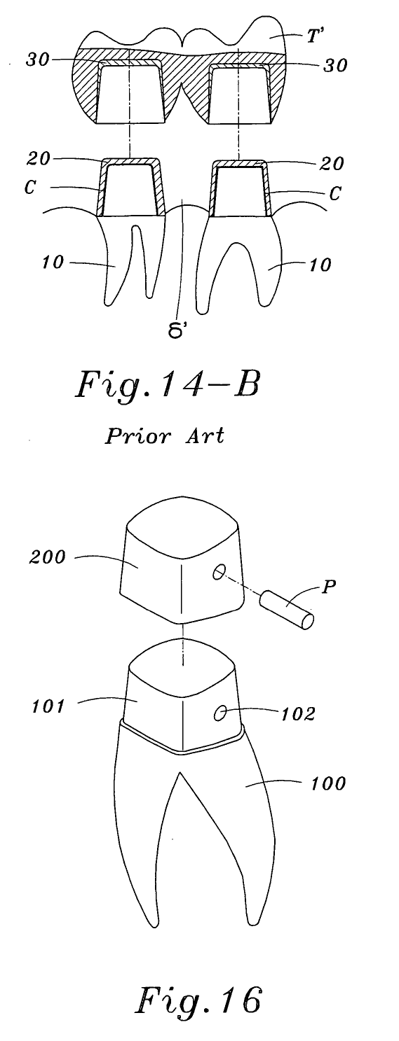

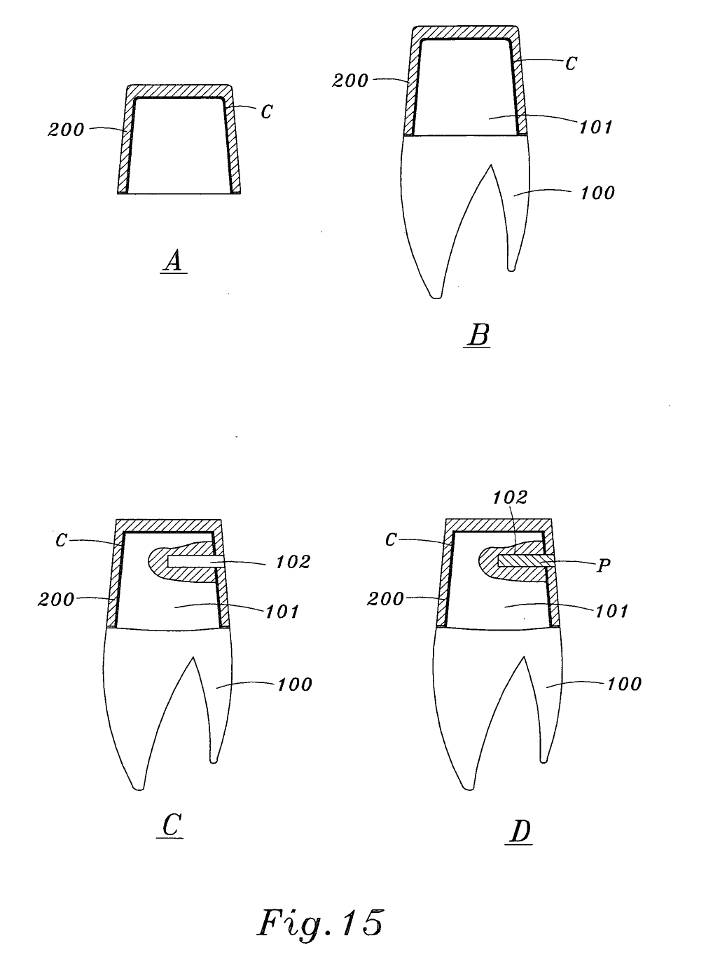

### DETAILED DESCRIPTION OF THE PREFERRED EMBODIMENT

The first preferred embodiment of the present invention involves a first step in which an inner crown 200 of a hollow construction is provided in an inner wall with a cement coating “C”, as shown in FIG. 15-A. Thereafter, the inner crown 200 is fitted over an abutment 101 of a natural tooth 100 td be restored, as shown in FIG. 15-B. The cement coating serves to hold the inner crown 200 and the abutment 101 together.

As shown in FIG. 15-C, a retaining hole 102 of an appropriated depth is bored in one upright wall of the inner crown 200 such that said retaining hole 102 extends into the abutment 101 of the natural tooth 100.

As shown in FIG. 15-D, the engagement of the inner crown 200 with the abutment 101 is reinforced by a retention pin “P” which is retained in the retaining hole 102 such that an outer end of the retention pin “P” is level with the outer surface of the upright wall of the inner crown 200.

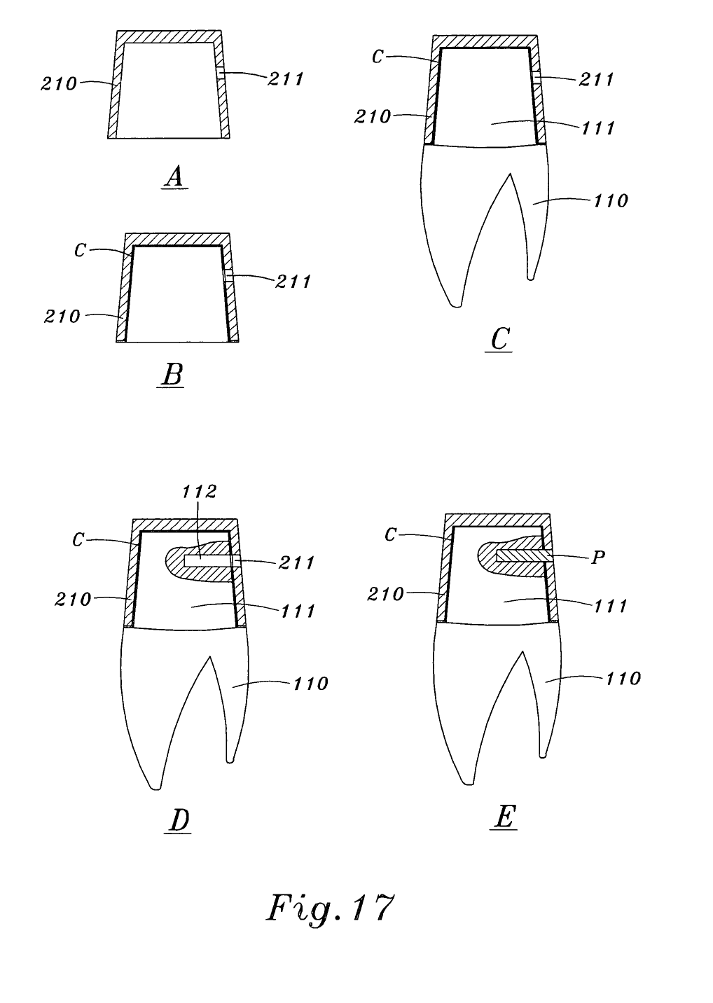

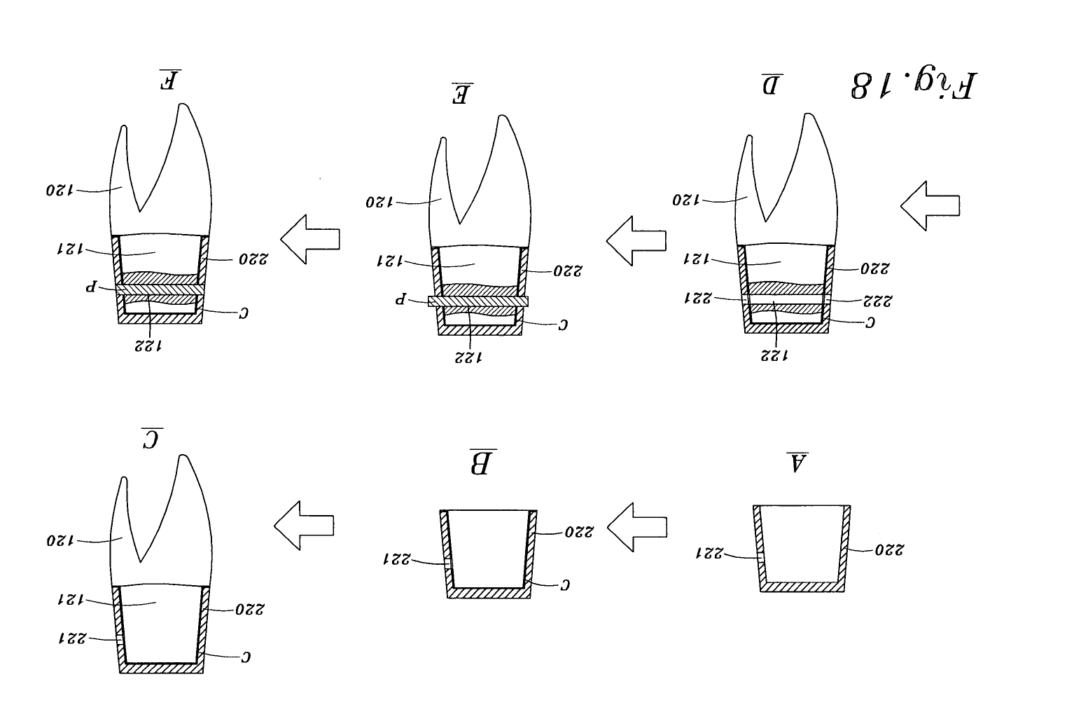

As shown in FIG. 17-A, the second preferred embodiment of the present invention comprises a first step in which an upright wall of a hollow inner crown 210 is provided with a through hole 211. Thereafter, the hollow inner crown 210 is provided in an inner wall with a cement coating “C”, as shown in FIG. 17-B. The inner crown 210 is then fitted over an abutment 111 of a natural tooth 110 to be restored, as shown in FIG. 17-C. The cement coating “C” serves to hold securely the inner crown 210 and the abutment 111. The inner crown 210 is provided in one upright wall with a through hole 211. The abutment 111 is provided with a retaining hole 112 of a depth and extending from the through hole 211 of the inner crown 210, as shown in FIG. 17-D. The engagement of the inner crown 210 with the abutment 111 is reinforced by a retention pin “P”, which is inserted into the retaining hole 112 of the abutment 111 via the through hole 211 of the inner crown 210. The retention pin “P” has an outer, which is level with the outer surface of the upright wall of the inner crown 210, as shown in FIG. 17-D, and FIG. 17-E.

The third preferred embodiment of the present invention comprises a first step in which an inner crown 220 of a hollow construction is provided in one upright wall with a first through hole 221, as shown in FIG. 18-A. Thereafter, the inner crown 220 is provided in an inner wall with a cement coating “C”, as shown in FIG. 18-B. The coated inner crown 220 is then fitted over an abutment 121 of a natural tooth 120 to be restored, as shown in FIG. 18-C. The cement “C” serves to hold the inner crown 220 and the abutment 121 firmly together. The abutment 121 is provided with a through hole 122 extending from the first through hole 221 of the inner crown 220. The inner crown 220 is further provided in other upright wall with a second through hole 222 in alignment with the through hole 122 of the abutment 121 and the first through hole 221 of the inner crown 220, as shown in FIG. 18-D. A retention pin “P” is inserted from the first through hole 221 into the through hole 122 of the abutment 121 such that both ends of the retention pin “P” are jutted out of the first through hole 221 and the second through hole 222 of the inner crown 220, as shown in FIG. 18-E. Both ends of the retention pin “P” are trimmed such that both ends of the retention pin “P” are level with the outer surface of the two upright walls of the inner crown 220, as shown in FIG. 18-F.

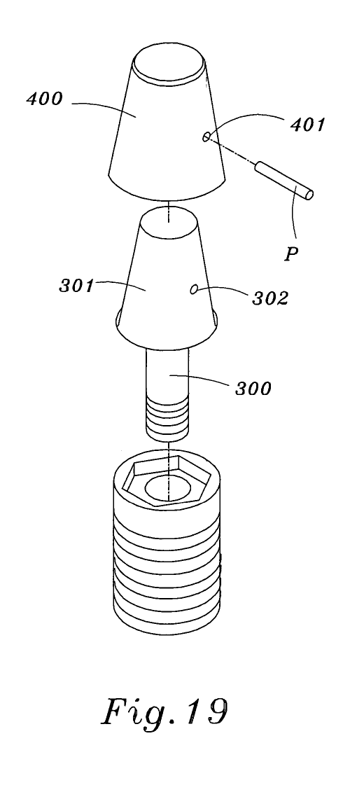

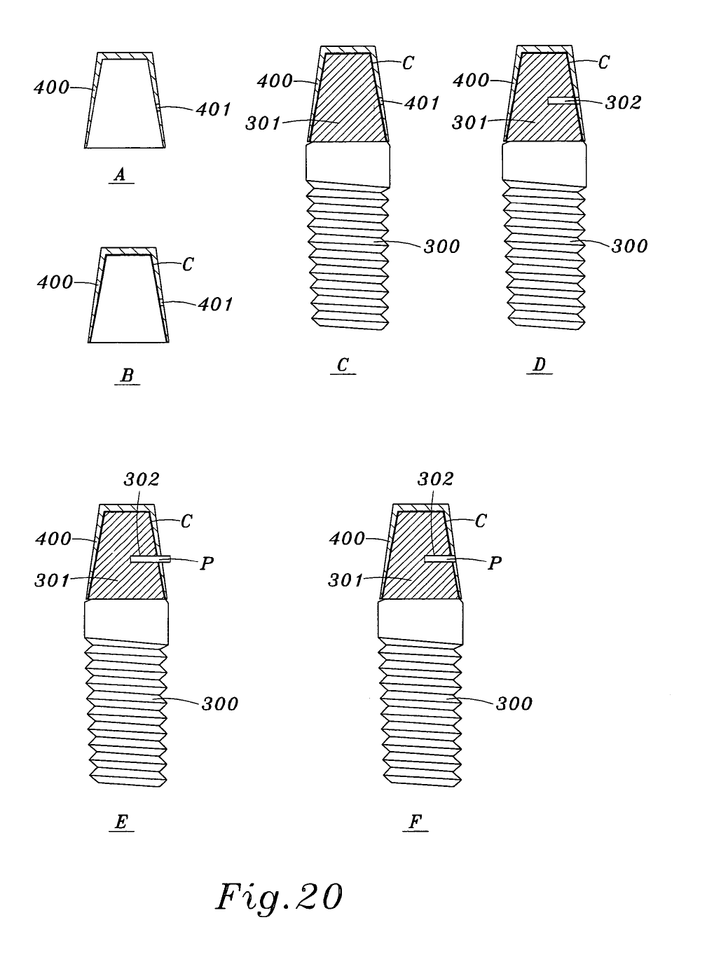

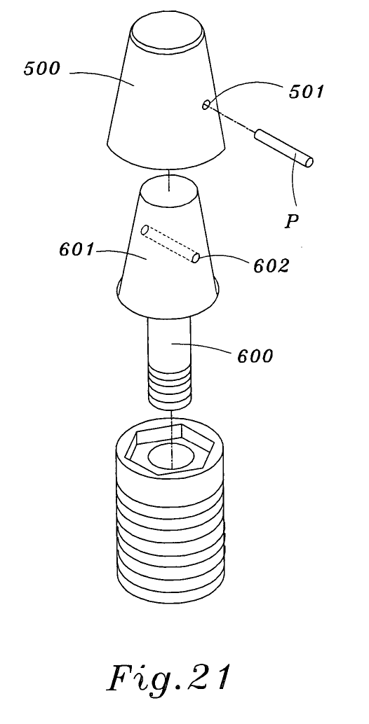

As illustrated in FIGS. 19 and 20, The fourth preferred embodiment of the present invention involves a first step in which an inner crown 400 is provided in one upright wall with a through hole 401, as shown in FIG. 20-A. Thereafter, the hollow inner crown 400 is provided in an inner wall with a cement coating “C”, as shown in FIG. 20-B. The coated inner crown 400 is then fitted over an abutment 301 of an artificial abutment tooth 300, as shown in FIG. 20-C. The cement holds the inner crown 400 and the abutment 301 firmly together. The inner crown 400 is provided in one upright wall with a through hole 401. Meanwhile the abutment 301 is provided with a retaining hole 302 extending from the through hole 401 of the inner crown 400. The retaining hole 302 is corresponding in hole diameter to the through hole 401, as shown in FIG. 20-D. The engagement of the inner crown 400 with the abutment 301 of the artificial abutment tooth 300 is reinforced by a retention pin “P”, which is inserted into the retaining hole 302 via the through hole 401, as shown in FIG. 20-E. An outer end of the retention pin “P” is so trimmed that it is level with the outer surface of the upright wall of the inner crown 400, as shown in FIG. 20-F.

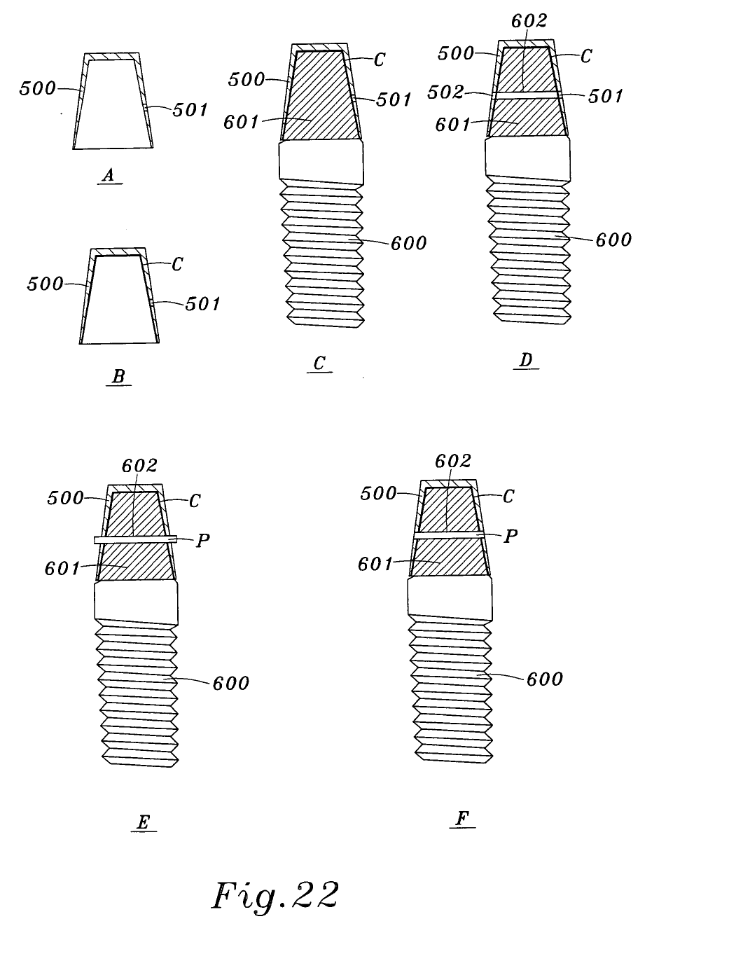

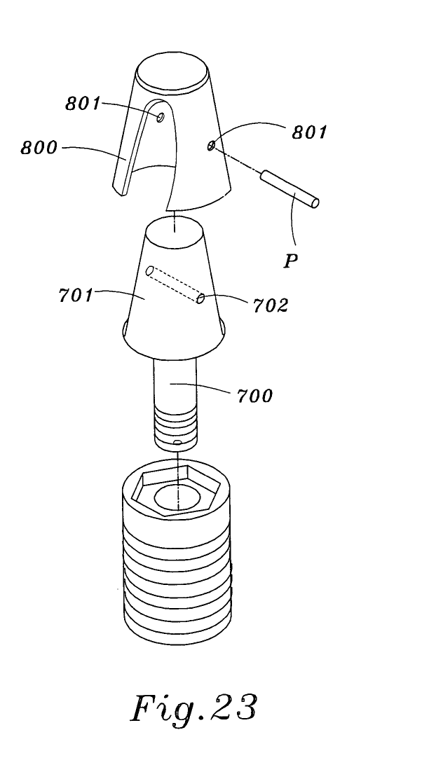

As illustrated in FIGS. 22 and 23, The fifth preferred embodiment of the present invention comprises an inner crown 500 which is provided in an upright wall thereof with a first through hole 501, as shown in FIG. 22-A. The inner crown 500 is then provided in an inner wall with a cement coating “C”, as shown in FIG. 22-B. The coated inner crown 500 is fitted over an abutment 601 of an artificial abutment tooth 600, as shown in FIG. 22-C. The cement coating is used to hold the inner crown 500 and the abutment 601 firmly together. The abutment 601 is then provided with a retaining through hole 602 extending from the through hole 501. In the meantime, the inner crown 500 is further provided in another upright wall thereof with a second through hole 502 in alignment with the retaining through hole 602 of the abutment 601 and the first through hole 501 of the inner crown 500, as shown in FIG. 22-D. The engagement of the inner crown 500 with the artificial abutment 601 is reinforced by a retention pin “P” which is inserted into the retaining through hole 602 via the first through hole 501 or the second through hole 502, as illustrated in FIG. 22-E. Finally, both ends of the retention pin “P” are so trimmed that they are level with the outer surface of the upright walls of the inner crown 500, as shown in FIG. 22-F.

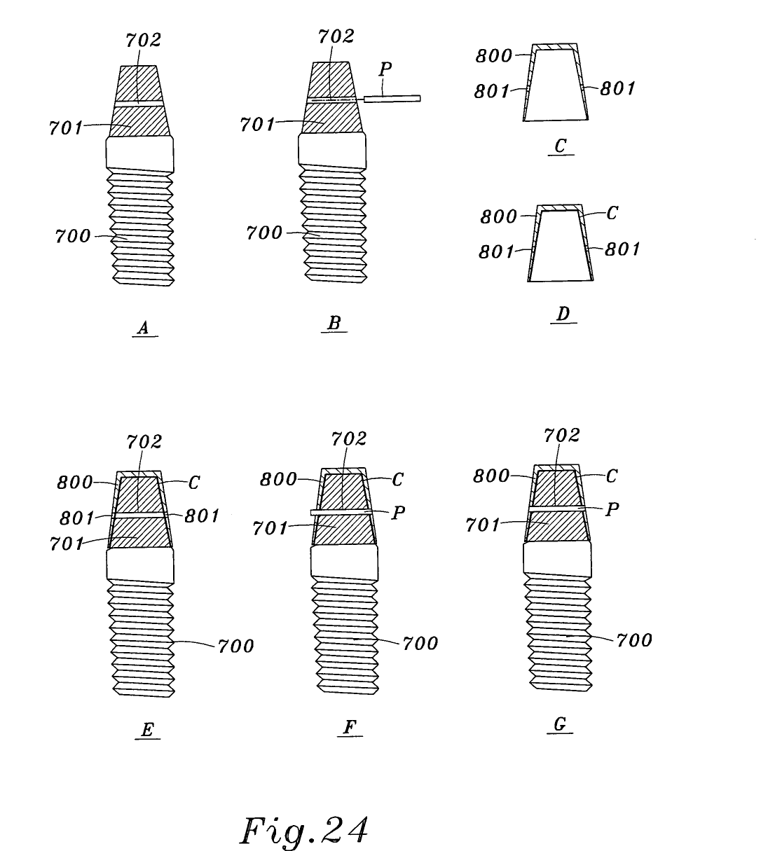

The sixth preferred embodiment of the present invention comprises an artificial abutment tooth 700 which is provided with an abutment 701 having a through hole 702, as shown in FIG. 24-A. A dental technician is then given the artificial abutment tooth 700 along with a retention pin “P” equal in diameter to the through hole 702 and greater in length than the through hole 702 for making a wax matrix of an inner crown 800, as shown in FIG. 24-B. The wax matrix is used for casting a metal inner crown 800 which is provided with two through holes 801 opposite to each other, as shown in FIG. 24-C. The metal inner crown 800 is then provided in an inner wall with a cement coating “C”, as shown in FIG. 24-D. The coated inner crown 800 is then fitted over the abutment 701 of the artificial abutment tooth 700 such that the two through holes 801 of the inner crown 800 are aligned with the through hole 702 of the abutment 701, as shown in FIG. 24-E. The retention pin “P” is inserted into the through hole 702 of the abutment 701 via one of the two through holes 801 of the inner crown 800, as illustrated in FIG. 24-F. Both ends of the retention pin “P” are so trimmed that they are level with outer surface of the two upright walls of the metal inner crown 800, as shown in FIG. 24-G.

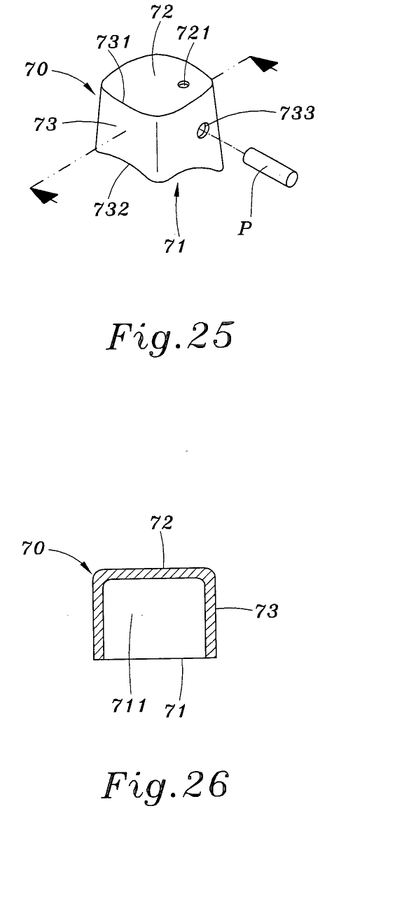

As shown in FIGS. 25 and 26, the inner crowns of the preferred embodiments of the present invention described above have a main body 70 which is formed of a bottom 71, a top 72, and an outer surface 73. The main body 70 is provided with a receiving space 711 extending from the bottom 71 toward the top 72 such that an inner wall of the receiving space 711 and the top 72 have an inclination, thereby oausing the inner diameter of the receiving space 711 to become progressively small toward the top 72. The top 72 is provided with a drain hole 721 in communication with the receiving space 711. The outer surface 73 has a top edge 731 contiguous to the top 72, and a bottom edge 732 contiguous to the bottom 71. The outer surface 73 is provided with a through hole 733 in communication with the receiving space 711. The through hole 733 is used to retain a retention pin “P”, as shown in FIG. 25. The drain hole 721 is used to discharge the excess cement which is coated in the inner wall of the receiving space 711. The cement residue can be easily removed from the top 72 of the inner crown by a dentist.

The embodiments of the present invention described above are to be regarded in all respects as being illustrative and nonrestrictive. Accordingly, the present invention may be embodied in other specific forms without deviating from the spirit thereof. The present invention is thereof to be limited only by the scopes of the following claims.

1. A method of preventing inner crown of removable restoration tooth from becoming disengaged with natural abutment tooth comprising the steps of:
(a) providing an inner wall of the inner crown with a cement coating:
(b) fitting the inner crown over the natural abutment such that the inner crown is secured to the natural abutment by the cement coating;
(c) providing in an upright wall of the inner crown with a through hole whereby the through hole extends into the natural abutment to form a retaining hole in the natural abutment;
(d) inserting a retention pin into the retaining hole of the natural abutment via the through hole of the inner crown; and
(e) trimming one end of the retention pin so that the one end of the retention pin is level with an outer surface of the upright wall of the inner crown.

2. A method of preventing inner crown of removable restoration tooth from becoming disengaged with natural abutment tooth, comprising the steps of:
(a) providing in an upright wall of the inner crown with a through hole;
(b) providing in an inner wall of the inner crown with a cement coating;
(c) fitting the inner crown over the natural abutment such that the inner crown is secured to the natural abutment by the cement coating;
(d) providing the natural abutment with a retaining hole via the through hole of the inner crown such that the retaining hole is aligned with the through hole, and that the retaining hole is corresponding in hole diameter to the through hole;
(e) inserting a retention pin into the retaining hole via the through hole of the inner crown; and
(f) trimming one end of the retention pin so that the one end of the retention pin is level with an outer surface of the upright wall of the inner crown.

3. A method of preventing inner crown of removable restoration tooth from becoming disengaged with natural abutment tooth, comprising the steps of:
(a) providing in one upright wall of the inner crown with a first through hole;
(b) providing an inner wall of the inner crown with a cement coating;
(c) fitting the inner crown over the natural abutment such that the inner crown is secured to the natural abutment by the cement coating;
(d) providing the natural abutment with a retaining through hole in communication with the first through hole of the inner crown;
(e) providing in other upright wall of the inner crown with a second through hole in communication with the retaining through hole of the natural abutment;
(f) inserting a retention pin into the retaining through hole of the natural abutment via the first through hole or the second through hole of the inner crown; and
(g) trimming both ends of the retention pin so that the both ends of the retention pin are level with an outer surface of the one upright wall and the other upright wall of the inner crown.

4. A method of preventing inner crown of removable restoration tooth from becoming disengaged with artificial abutment tooth comprising the steps of:
(a) providing an upright wall of the inner crown with a through hole;
(b) providing an inner wall of the inner crown with a cement coating;
(c) fitting the inner crown over the artificial abutment such that the inner crown is secured to the artificial abutment by the cement coating;
(d) providing the artificial abutment with a retaining hole extending from the through hole of the inner crown such that the retaining hole is corresponding in hole diameter to the through hole, and that the retaining hole is in alignment with the through hole;
(e) inserting a retention pin into the retaining hole of the artificial abutment via the through hole of the inner crown; and
(f) trimming one end of the retention pin such that the one end of the retention pin is level with an outer surface of the upright wall of the inner crown.

5. A method of preventing inner crown of removable restoration tooth from becoming disengaged with artificial abutment tooth comprising the steps of:
(a) providing one upright wall of the inner crown with a first through hole;
(b) providing an inner wall of the inner crown with a cement coating;
(c) fitting the inner crown over the artificial abutment such that the inner crown is secured to the artificial abutment by the cement coating;
(d) providing the artificial abutment with a retaining through hole extending from the first through hole such that the retaining through hole is in communication with and in alignment with the first through hole;
(e) providing other upright wall of the inner crown with a second through hole in communication with and in alignment with the retaining through hole of the artificial abutment;
(f) inserting a retention pin into the retaining through hole via the first through hole or the second through hole such that two ends of the retention pin are jutted out of the first through hole and the second through hole; and
(g) trimming the two ends of the retention pin such that one of the two ends of the retention pin is level with an outer surface of the one upright wall of the inner crown, and that other one of the two ends of the retention pin is level with an outer surface of the other upright wall of the inner crown.

6. A method of preventing inner crown of removable restoration tooth from becoming disengaged with artificial abutment tooth, comprising the steps of:
(a) providing the artificial abutment with a through hole such that both ends of the through hole are located in two upright walls of the artificial abutment;
(b) providing the artificial abutment with a retention pin having an outer diameter which is corresponding to a hole diameter of the through hole of the artificial abutment whereby the retention pin is greater in length that the through hole of the artificial abutment;
(c) making an inner crown wax matrix according to the artificial abutment and the retention pin of the step (b);
(d) casting a metal inner crown according to the inner crown wax matrix such that the metal inner crown is provided with two through holes which are respectively located in two upright walls of the metal inner crown;
(e) providing an inner wall of the metal inner crown with a cement coating;
(f) fitting the metal inner crown over the artificial abutment such that the through holes of the metal inner crown are in alignment with and in communication with the through hole of the artificial abutment;
(g) inserting the retention pin into the through hole of the artificial abutment via one of the two through holes of the metal inner crown; and
(h) trimming two ends of the retention pin such that one of the two ends of the retention pin is level with an outer surface of one of the two upright walls of the metal inner crown, and that other one of the two ends of the retention pin is level with an outer surface of other one of the two upright walls of the metal inner crown.

7. An inner crown of a removable restoration tooth, having a bottom, a top, an outer surface, and an interior provided with a space extending from said bottom toward said top in such a manner that an inner diameter of the space is progressively smaller from said bottom toward said top, said outer surface having a top edge contiguous to said top, said outer surface further having a bottom edge contiguous to said bottom; wherein said inner crown is provided with a through hole in communication with said space of the outer surface.

8. An inner crown of a removable restoration tooth, as recited in claim 7, wherein said top of said inner crown thereof with a drain hole in communication with said space.
